(19) United States
(12) Patent Application Publication
(10) Pub. No.: US 2019/0375239 A1
(43) Pub. Date: Dec. 12, 2019

(54) WHEEL COMPRISING A NON-PNEUMATIC TIRE

(71) Applicant: Camso Inc., Magog (CA)

(72) Inventor: Ronald H. Thompson, Greenville, SC (US)

(21) Appl. No.: 16/472,330

(22) PCT Filed: Dec. 21, 2017
(86) PCT No.: PCT/CA2017/051577

§ 371 Date: Jun. 21, 2019

Related U.S. Application Data
(60) Provisional application No. 62/437,312, filed on Dec. 21, 2016.

(51) Int. Cl. B60C 7/24; B60B 9/26

(52) U.S. Cl. CPC B60C 7/24; B60C 2200/08; B60B 9/26

(57) ABSTRACT

A wheel (e.g., a caster wheel) for a vehicle or other device, in which the wheel comprises a non-pneumatic tire and may be designed to enhance its use and performance and/or use and performance of the vehicle or other device, including, for example, by being less laterally stiff (e.g., less torsionally stiff) to better manage lateral loading on the wheel (e.g., when the vehicle or other device turns and/or encounters an obstacle, such as a stump, root, curb, etc., at a lateral side of the wheel) and/or by better distributing pressure applied by the wheel onto the ground (e.g., to reduce, minimize or eliminate potential for damaging the ground).

### CROSS-REFERENCE TO RELATED APPLICATION

This application claims priority from U.S. Provisional Patent Application 62/437,312 filed on Dec. 21, 2016 and hereby incorporated by reference herein.

### FIELD

This disclosure relates generally to wheels comprising non-pneumatic tires (NPTs), including caster wheels and other wheels, for vehicles, such as riding lawnmowers (e.g., zero-turning-radius (ZTR) mowers) and other vehicles, and/or other devices.

### BACKGROUND

Wheels for vehicles and other devices may comprise non-pneumatic tires (sometimes referred to as NPTs) instead of pneumatic tires.

One type of wheel which may have a pneumatic or non-pneumatic tire is a caster wheel, which may be part of a vehicle or other device and configured to facilitate movement of the vehicle or other device.

For example, certain riding lawnmowers such as zero-turning-radius (ZTR) mowers have drive wheels in their rear to move the ZTR mower on the ground and caster wheels in their front to support part of the ZTR mower's weight (e.g., including of a mowing deck) and provide pitch and roll stability. These caster wheels can either be pneumatic bias ply tires mounted on a steel wheel, or semi-pneumatic solid rubber or solid polyurethane tires mounted on a steel wheel.

Pneumatic tires are subject to flats. Semi-pneumatic tires of solid rubber or solid polyurethane are stiff in the vertical and lateral directions. Thus, impact loads from stumps, roots, curbs, or other obstacles encountered when mowing a yard or field are transmitted to the frame of the vehicle and ultimately to the operator.

A caster wheel comprising a stiff tire can damage the turf of a lawn. During zero-turn operation, the caster wheels rapidly traverse a circular path around the mower center of rotation and are dragged across the lawn surface. A high contact pressure between the turf and the tire can result in tearing or otherwise damaging the lawn surface.

Negative effects of high contact pressure and high stiffness can be exacerbated by the high torsional stiffness of the mower frame. Thus, if only one of the caster wheels encounters an unevenness in the lawn surface, the load carried by each caster wheel will be significantly different. This load differential increases as the tire vertical stiffness increases which results in one of the caster wheels becoming significantly overloaded. With a stiff tire, the contact pressure between the turf and the tire greatly increases as the vertical load increases.

Additionally, the zero-turn maneuver can result in lateral impacts of the caster wheel against obstacles, such as curbs or tree stumps. A solid rubber or solid polyurethane tire mounted on a steel wheel can be very stiff in the lateral direction. Thus, a lateral impact can result in very high impact forces between the caster wheel and the obstacle. This force can unseat the tire, damage the caster wheel or damage the mower.

For these and other reasons, there is a need to improve wheels comprising non-pneumatic tires, including caster wheels.

### SUMMARY

According to various aspects, this disclosure relates to a wheel (e.g., a caster wheel) for a vehicle or other device, in which the wheel comprises a non-pneumatic tire and may be designed to enhance its use and performance and/or use and performance of the vehicle or other device, including, for example, by being less laterally stiff (e.g., less torsionally stiff) to better manage lateral loading on the wheel (e.g., when the vehicle or other device turns and/or encounters an obstacle, such as a stump, root, curb, etc., at a lateral side of the wheel) and/or by better distributing pressure applied by the wheel onto the ground (e.g., to reduce, minimize or eliminate potential for damaging the ground).

For example, according to an aspect, this disclosure relates to a wheel comprising a non-pneumatic tire. The wheel has a lateral direction parallel to an axis of rotation of the wheel and is resiliently deformable in the lateral direction of the wheel.

According to another aspect, this disclosure relates to a vehicle comprising a wheel. The wheel comprises a non-pneumatic tire. The wheel has a lateral direction parallel to an axis of rotation of the wheel and is resiliently deformable in the lateral direction of the wheel.

According to another aspect, this disclosure relates to a wheel comprising a non-pneumatic tire. The wheel as a lateral direction parallel to an axis of rotation of the wheel and is resiliently deformable in the lateral direction of the wheel. The wheel has a lateral stiffness of no more than 80 N/mm.

According to another aspect, this disclosure relates to a wheel comprising a non-pneumatic tire. The wheel as a lateral direction parallel to an axis of rotation of the wheel and a radial direction normal to the lateral direction of the wheel. The wheel is resiliently deformable in the lateral direction of the wheel. The wheel has a lateral stiffness that is no more than a radial stiffness of the wheel.

According to another aspect, this disclosure relates to a wheel comprising a non-pneumatic tire. The wheel as a lateral direction parallel to an axis of rotation of the wheel, a vertical direction normal to the lateral direction of the wheel and a horizontal direction normal to the axis of rotation of the wheel and the vertical direction of the wheel. The wheel is resiliently deformable torsionally about the horizontal direction of the wheel. The wheel has a torsional stiffness about the horizontal direction of the wheel that is no more than 30,000 N-mm/deg.

According to another aspect, this disclosure relates to a wheel comprising a non-pneumatic tire and an annular support. The non-pneumatic tire comprises an annular beam configured to deflect at a contact patch of the non-pneumatic tire. The annular support is disposed radially inwardly of the annular beam and is resiliently deformable such that, when the non-pneumatic tire is loaded, a lower portion of the annular support below an axis of rotation of the wheel is compressed and an upper portion of the annular support above the axis of rotation of the wheel is in tension. A pressure is highest in a central portion of the contact patch of the non-pneumatic tire.

According to another aspect, this disclosure relates to a wheel comprising a non-pneumatic tire and a hub for connecting the wheel to an axle. The wheel has a lateral direction parallel to an axis of rotation of the wheel and the hub is resiliently deformable in the lateral direction of the wheel.

According to another aspect, this disclosure relates to a wheel comprising a non-pneumatic tire and a hub for connecting the wheel to an axle. The wheel has a lateral direction parallel to an axis of rotation of the wheel, a vertical direction normal to the axis of rotation of the wheel and a horizontal direction normal to the axis of rotation of the wheel and the vertical direction of the wheel. The hub is resiliently deformable torsionally about the horizontal direction of the wheel.

According to another aspect, this disclosure relates to a wheel comprising a non-pneumatic tire and a hub for connecting the wheel to an axle. The wheel has a lateral direction parallel to an axis of rotation of the wheel. The hub comprises an inner annular member, an outer annular member radially outward of the inner annular member, and a resiliently-deformable intermediate member interconnecting the inner annular member and the outer annular member. The resiliently-deformable intermediate member of the hub is smaller in the lateral direction of the wheel than the inner annular member of the hub and the outer annular member of the hub.

According to another aspect, this disclosure relates to a caster wheel comprising a non-pneumatic tire and an annular support. The non-pneumatic tire comprises an annular beam configured to deflect at a contact patch of the non-pneumatic tire. The annular support is disposed radially inwardly of the annular beam and is resiliently deformable such that, when the non-pneumatic tire is loaded, a lower portion of the annular support below an axis of rotation of the wheel is compressed and an upper portion of the annular support above the axis of rotation of the wheel is in tension. The caster wheel has a lateral direction parallel to an axis of rotation of the caster wheel and the caster wheel is resiliently deformable in the lateral direction of the caster wheel. A pressure is highest in a central portion of the contact patch of the non-pneumatic tire.

According to another aspect, this disclosure relates to a caster wheel comprising a non-pneumatic tire and an annular support. The non-pneumatic tire comprises an annular beam configured to deflect at a contact patch of the non-pneumatic tire. The annular support is disposed radially inwardly of the annular beam and is resiliently deformable such that, when the non-pneumatic tire is loaded, a lower portion of the annular support below an axis of rotation of the wheel is compressed and an upper portion of the annular support above the axis of rotation of the wheel is in tension. A pressure is highest in a central portion of the contact patch of the non-pneumatic tire when loaded to a vertical load of 2000 N. an outer diameter of the caster wheel is no more than 14″ and a width of the caster wheel is no more than 6.5″.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments is provided below, by way of example only, with reference to the accompanying drawings, in which:

FIG. 1 shows a side-elevation view of a vehicle comprising caster wheels in accordance with an embodiment;

FIG. 2A shows a plan view of the vehicle of FIG. 1 mower in zero turn operation with greater positive torque applied to a left rear wheel;

FIG. 2B shows a plan view of the vehicle of FIG. 1 mower in zero turn operation with greater positive torque applied to a right rear wheel;

FIG. 3 shows an isometric view of a caster wheel according to an embodiment;

FIG. 4 shows a side-elevation view of the caster wheel of FIG. 3;

FIG. 5 shows a side-elevation view of the caster wheel of FIG. 5 as it engages the ground;

FIG. 6A shows a side-elevation view in the YZ plane of the caster wheel of FIG. 3;

FIG. 6B shows a side-elevation cutaway view in the XZ plane taken along line 6B-6B of FIG. 6A;

FIG. 7A shows a side-elevation view in the XZ plane of the caster wheel of FIG. 3;

FIG. 7B shows a side-elevation cutaway view in the YZ plane taken along line 7B-7B of FIG. 7A;

FIG. 7C shows a side-elevation cutaway view in the YZ plane of a caster wheel according to an embodiment;

FIG. 8 shows an isometric view of a mount for mounting the caster wheel of FIG. 3 according to an embodiment;

FIG. 9A shows FEM predictions for load vs. deflection of a caster wheel with elastomer A and a caster wheel with elastomer B according to two embodiments and of a prior art caster wheel;

FIG. 9B shows an isometric cutaway view of the prior art caster wheel of FIG. 9A;

FIG. 10A shows an example of a test for determining a lateral stiffness of the wheel;

FIG. 10B shows FEM predictions for X axis torque vs. angular displacement at load Fz=1000N of the caster wheel with elastomer A and the prior art caster wheel of FIG. 9A;

FIG. 10C shows the FEM geometry of the caster wheel of FIG. 3 undergoing torsional deflection around the X axis;

FIG. 10D shows FEM geometries of the caster wheel of FIG. 3 when subjected and not subjected to a lateral load; and

FIGS. 11A to 11D show FEM predictions of pressure at a contact area of the caster wheel with elastomer A and the prior art caster wheel of FIG. 9A under two different loads against a deformable ground.

It is to be expressly understood that the description and drawings are only for purposes of illustrating certain embodiments and are an aid for understanding. They are not intended to be limiting.

### DETAILED DESCRIPTION OF EMBODIMENTS

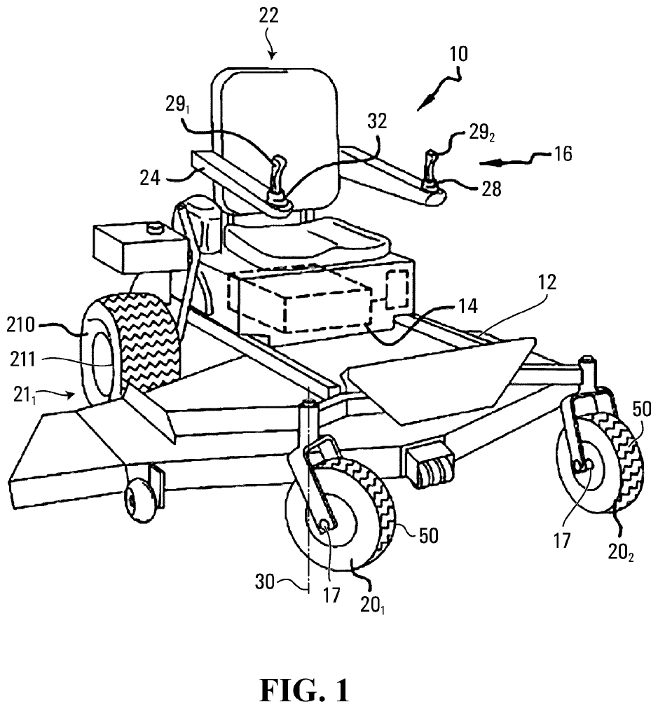

FIG. 1 show an example of a vehicle 10 comprising wheels 20₁, 20₂ in accordance with an embodiment. In this embodiment, the vehicle 10 is a riding lawnmower to mow lawn. More particularly, in this embodiment, the riding lawnmower 10 is a zero-turning-radius (ZTR) mower (a.k.a., zero-turn mower) and the wheels 20₁, 20₂ are caster wheels in the front of the ZTR mower 10. The ZTR mower 10 is configured to turn with a substantially zero turning radius, i.e., turn a full 360 degrees with substantially no forward or backward movement. In this example, the ZTR mower 10 comprises a frame 12, a powertrain 14, a steering system 16, the caster wheels 20₁, 20₂, wheels 21₁, 21₂ in a rear of the ZTR mower 10, a mowing implement 18, a seat 22, and a user interface 24, which enable a user of the ZTR mower 10 to ride it on the ground and mow the lawn. The ZTR mower 10 has a longitudinal direction, a widthwise direction, and a height direction.

In this embodiment, as further discussed later, each caster wheel 20₁ is non-pneumatic (i.e., airless) and may be designed to enhance its use and performance and/or use and performance of the ZTR mower 10, including, for example, by being less laterally stiff (e.g., less torsionally stiff) to better manage lateral loading on the caster wheel 20ᵢ (e.g., when the ZTR mower 10 turns and/or encounters an obstacle, such as a stump, root, curb, etc., at a lateral side of the caster wheel 20ᵢ) and/or by better distributing pressure applied by the caster wheel 20ᵢ onto the ground (e.g., to reduce, minimize or eliminate potential for damaging the lawn).

The powertrain 14 is configured for generating motive power and transmitting motive power to the wheels 21₁, 21₂ to propel the ZTR mower 10 on the ground. To that end, the powertrain 14 comprises a prime mover 26, which is a source of motive power that comprises one or more motors. For example, in this embodiment, the prime mover 26 comprises an internal combustion engine. In other embodiments, the prime mover 26 may comprise another type of motor (e.g., an electric motor) or a combination of different types of motor (e.g., an internal combustion engine and an electric motor). The prime mover 26 is in a driving relationship with the wheels 21₁, 21₂. That is, the powertrain 14 transmits motive power generated by the prime mover 26 to the wheels 21₁, 21₂ (e.g., via a transmission and/or a differential) in order to drive (i.e., impart motion to) the wheels 21₁, 21₂. In that sense, the wheels 21₁, 21₂ may be referred to as “drive wheels”.

The steering system 16 is configured to enable the user to steer the ZTR mower 10 on the ground. To that end, the steering system 16 comprises a steering device 28 that is part of the user interface 24 and operable by the user to direct the ZTR mower 10 on the ground. In this embodiment, the steering device 28 comprises a pair of handles 29₁, 29₂. The steering device 28 may comprise any other steering component that can be operated by the user to steer the ZTR mower 10 in other embodiments. In this example, the steering system 16 is responsive to the user interacting with the handles 29₁, 29₂ by causing the powertrain 14 to apply differential power to the drive wheels 21₁, 21₂ to induce yaw of the ZTR mower 10 in order to turn the ZTR mower 10 to move in a desired direction. Meanwhile, the caster wheels 20₁, 20₂ are turnable in response to input of the user at the steering device 28 to change their orientation relative to the frame 12 of the ZTR mower 10. More particularly, in this example, each of the caster wheels 20₁, 20₂ is pivotable about a steering axis 30 relative to the frame 12 of the ZTR mower 10.

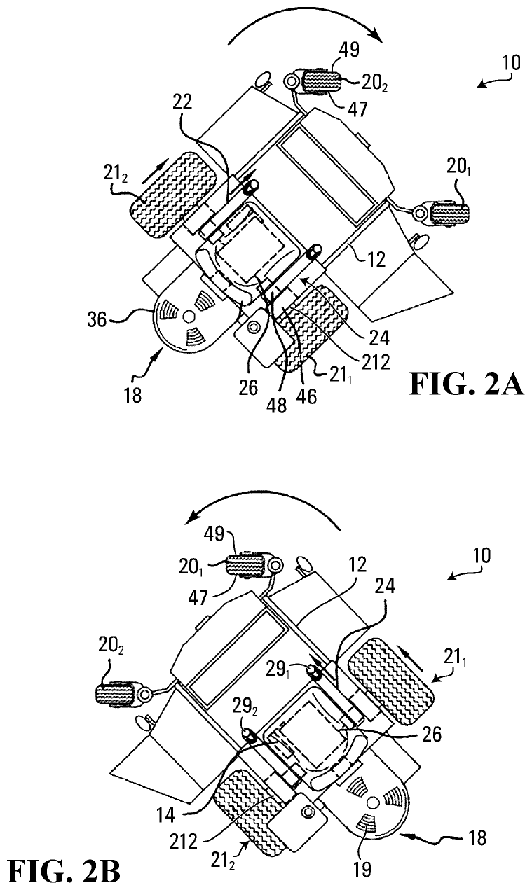

FIGS. 2A and 2B show plan views of the ZTR mower in zero turn operation. In FIG. 2A, the vehicle has a greater positive torque applied to the left rear wheel 16. This creates a yaw in the clockwise sense. In FIG. 2B, the vehicle has a greater positive torque applied to the right rear wheel. This creates a yaw in the counter clockwise sense. In FIG. 2A, the caster wheels 20₁, 20₂ can be rapidly forced in a clockwise arc trajectory; in FIG. 2B, the caster wheels 20₁, 20₂ can be rapidly forced in a counter-clockwise arc trajectory. In these types of maneuvers, the caster wheels 20₁, 20₂ can be subject to obstacle impacts such as curbs and stumps.

The user interface 24 allows the user to interact with the ZTR mower 10. More particularly, the user interface 24 comprises an accelerator, a brake control, and the steering device 28 that are operated by the user to control motion of the ZTR mower 10 on the ground. The user interface 24 may also comprise an instrument panel (e.g., a dashboard) which provides indicators (e.g., a speedometer indicator, a tachometer indicator, etc.) to convey information to the user.

The mowing implement 18 is configured to engage and mow the lawn. For example, the mowing implement 18 may comprise a blade 19 powered by power derived from the powertrain 14 to move and mow the lawn.

The drive wheels 21₁, 21₂ and the caster wheels 20₁, 20₂ engage the ground. More particularly, in this example, the drive wheels 21₁, 21₂ provide traction to the ZTR mower 10 and support a substantial part (e.g., a majority) of a weight of the ZTR mower 10, including a weight of the powertrain 14, and the user in use, while the caster wheels 20₁, 20₂ support a lesser part of the weight of the ZTR mower 10, such as part of the mowing implement 18, and provide pitch and roll stability. The drive wheels 21₁, 21₂ and the caster wheels 20₁, 20₂ provide shock absorption when the ZTR mower 10 travels on the ground. In this example, the drive wheels 21₁, 21₂ are larger in diameter than the caster wheels 20₁, 20₂.

In this embodiment, each one of the drive wheels 21₁, 21₂ comprises a tire 210 for contacting the ground and a hub 211 for connecting each one of the drive wheel 21₁, 21₂ to an axle 212 of the ZTR mower 10. More particularly, in this embodiment, the tire 210 is a pneumatic tire.

Each caster wheel 20ᵢ comprises a non-pneumatic tire 34 for contacting the ground and a hub 32 for connecting the caster wheel 20ᵢ to an axle 17 that is supported by the ZTR mower 10. The non-pneumatic tire 34 is a compliant wheel structure that is not supported by gas (e.g., air) pressure and that is resiliently deformable (i.e., changeable in configuration) as the caster wheel 20ᵢ contacts the ground.

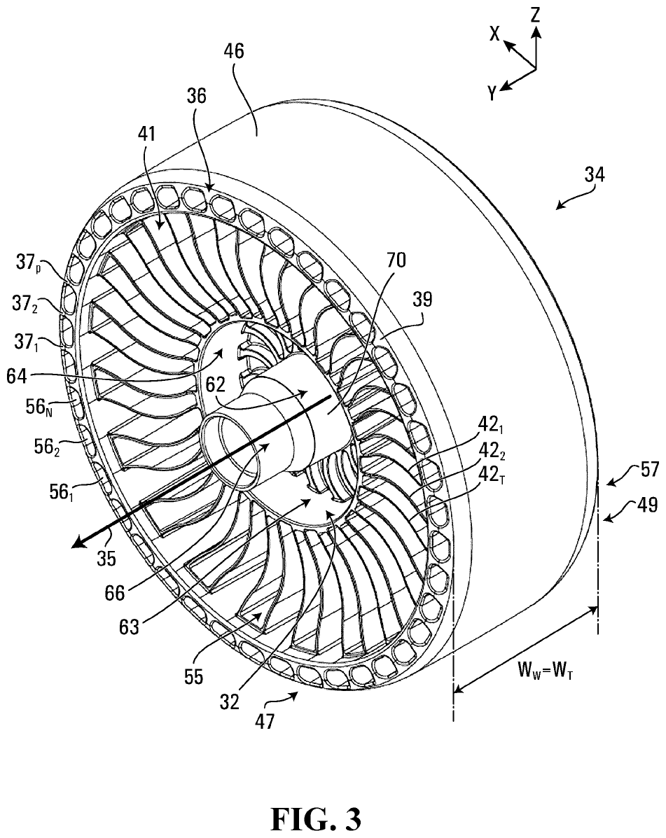

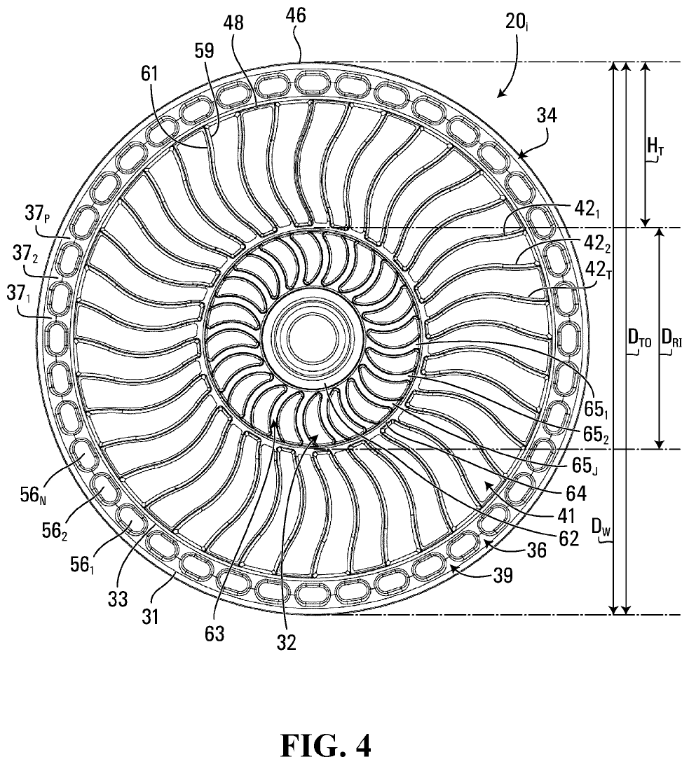

With additional reference to FIGS. 3 to 7C, the caster wheel 20ᵢ has an axis of rotation 35, which defines an axial direction (also referred to as a “Y” direction) parallel to the axis of rotation 35 of the caster wheel 20ᵢ a vertical direction (also referred to as a “Z” direction) that is normal to the axis of rotation 35 of the caster wheel 20ᵢ and a horizontal direction (also referred to as a “X” direction) that is normal to the axis of rotation 35 of the caster wheel 20ᵢ and the vertical direction and can be viewed as corresponding to a heading direction of the caster wheel 20ᵢ. The axial direction of the caster wheel 20ᵢ can also be referred to as a lateral or widthwise direction of the caster wheel 20ᵢ while each of the vertical direction and the horizontal direction of the caster wheel 20ᵢ can also be referred to as radial direction of the caster wheel 20ᵢ. The caster wheel 20ᵢ also has a circumferential direction (also referred to as a “C” direction). The caster wheel 20ᵢ has an outer diameter D_{W} and a width W_{W}. It comprises an inboard lateral side 47 for facing towards a center of the ZTR mower 10 in the widthwise direction of the ZTR mower 10 and an outboard lateral side 49 opposite its inboard lateral side 47.

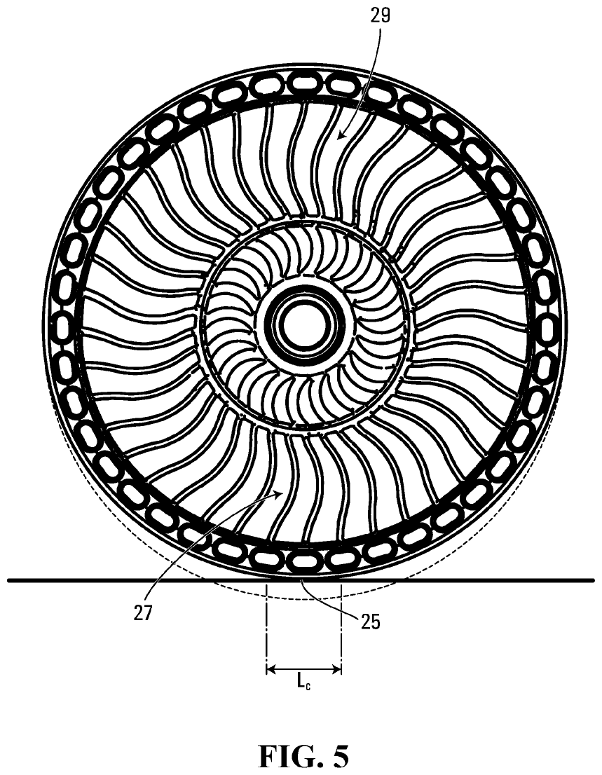

As shown in FIG. 5, when it is in contact with the ground, the caster wheel 20ᵢ has an area of contact 25 with the ground, which may be referred to as a “contact patch” of the caster wheel 20ᵢ with the ground. The contact patch 25 of the caster wheel 20ᵢ which is a contact interface between the non-pneumatic tire 34 and the ground, has a dimension L_{C} in the horizontal direction of the caster wheel 20ᵢ and a dimension W_{C} in the lateral direction of the caster wheel 20ᵢ.

The non-pneumatic tire 34 comprises an annular beam 36 and an annular support 41 that is disposed between the annular beam 36 and the hub 32 of the caster wheel 20ᵢ and configured to support loading on the caster wheel 20ᵢ as the caster wheel 20ᵢ engages the ground. In this embodiment, the non-pneumatic tire 34 is tension-based such that the annular support 41 is configured to support the loading on the caster wheel 20ᵢ by tension. That is, under the loading on the caster wheel 20ᵢ the annular support 41 is resiliently deformable such that a lower portion 27 of the annular support 41 between the axis of rotation 35 of the caster wheel 20ᵢ and the contact patch 25 of the caster wheel 20ᵢ is compressed and an upper portion 29 of the annular support 41 above the axis of rotation 35 of the caster wheel 20ᵢ is in tension to support the loading.

The annular beam 36 of the tire 34 is configured to deflect under the loading on the caster wheel 20ᵢ at the contact patch 25 of the caster wheel 20ᵢ with the ground. In this embodiment, the annular beam 36 is configured to deflect such that it applies a homogeneous contact pressure along the dimension L_{C} of the contact patch 25 of the caster wheel 20ᵢ with the ground.

More particularly, in this embodiment, the annular beam 36 comprises a shear band 39 configured to deflect predominantly by shearing at the contact patch 25 under the loading on the caster wheel 20ᵢ. That is, under the loading on the caster wheel 20ᵢ the shear band 39 deflects significantly more by shearing than by bending at the contact patch 25. The shear band 39 is thus configured such that, at a center of the contact patch 25 of the caster wheel 20ᵢ in the vertical direction of the caster wheel 20ᵢ a shear deflection of the shear band 39 is significantly greater than a bending deflection of the shear band 39. For example, in some embodiments, at the center of the contact patch 25 of the caster wheel 20ᵢ in the vertical direction of the caster wheel 20ᵢ a ratio of the shear deflection of the shear band 39 over the bending deflection of the shear band 39 may be at least 1.2, in some cases at least 1.5, in some cases at least 2, in some cases at least 3, and in some cases even more (e.g., 4 or more). For instance, in some embodiments, the annular beam 36 may be designed based on principles discussed in U.S. Patent Application Publication No. 2014/0367007, which is hereby incorporated by reference herein, in order to achieve the homogeneous contact pressure along the length L_{C} of the contact patch 25 of the caster wheel 20ᵢ with the ground.

In this example of implementation, the shear band 39 comprises an outer rim 31, an inner rim 33, and a plurality of openings 56₁-56_{N} between the outer rim 31 and the inner rim 33. The shear band 39 comprises a plurality of interconnecting members 37₁-37_{P} that extend between the outer rim 31 and the inner rim 33 and are disposed between respective ones of the openings 56₁-56_{N}. The interconnecting members 37₁-37_{P} may be referred to as “webs” such that the shear band 39 may be viewed as being “web-like” or “webbing”. The shear band 39, including the openings 56₁-56_{N} and the interconnecting members 37₁-37_{P}, may be arranged in any other suitable way in other embodiments.

The openings 56₁-56_{N} of the shear band 39 help the shear band 39 to deflect predominantly by shearing at the contact patch 25 under the loading on the caster wheel 20ᵢ. In this embodiment, the openings 56₁-56_{N} extend from the inboard lateral side 47 to the outboard lateral side 49 of the tire 34. That is, the openings 56₁-56_{N} extend laterally though the shear band 39 in the lateral direction of the caster wheel 20ᵢ.

The openings 56₁-56_{N} may extend laterally without reaching the inboard lateral side 47 and/or the outboard lateral side 49 of the tire 34 in other embodiments. The openings 56₁-56_{N} may have any suitable shape. In this example, a cross-section of each of the openings 56₁-56_{N} is circular. The cross-section of each of the openings 56₁-56_{N} may be shaped differently in other examples (e.g., polygonal, partly curved and partly straight, etc.). In some cases, different ones of the openings 56₁-56_{N} may have different shapes. In some cases, the cross-section of each of the openings 56₁-56_{N} may vary in the lateral direction of the caster wheel 20ᵢ. For instance, in some embodiments, the openings 56₁-56_{N} may be tapered in the lateral direction of the caster wheel 20ᵢ such that their cross-section decreases inwardly axially (e.g., to help minimize debris accumulation within the openings 56₁-56_{N}).

In this embodiment, the tire 34 comprises a tread 50 for enhancing traction between the tire 34 and the ground. The tread 50 is disposed about an outer peripheral extent 46 of the annular beam 36, in this case about the outer rim 31 of the shear band 39. More particularly, in this example the tread 50 comprises a tread base 43 that is at the outer peripheral extent 46 of the annular beam 36 and a plurality of tread projections 52₁-52_{T} that project from the tread base 52. The tread 50 may be implemented in any other suitable way in other embodiments (e.g., may comprise a plurality of tread recesses, etc.).

The annular support 41 is configured to support the loading on the caster wheel 20ᵢ as the caster wheel 20ᵢ engages the ground. As mentioned above, in this embodiment, the annular support 41 is configured to support the loading on the caster wheel 20ᵢ by tension. More particularly, in this embodiment, the annular support 41 comprises a plurality of support members 42₁-42_{T} that are distributed around the tire 34 and resiliently deformable such that, under the loading on the wheel 20ᵢ, lower ones of the support members 42₁-42_{T} in the lower portion 27 of the annular support 41 (between the axis of rotation 35 of the caster wheel 20ᵢ and the contact patch 25 of the caster wheel 20ᵢ) are compressed and bend while upper ones of the support members 42₁-42_{T} in the upper portion 29 of the annular support 41 (above the axis of rotation 35 of the caster wheel 20ᵢ) are tensioned to support the loading. As they support load by tension when in the upper portion 29 of the annular support 41, the support members 42₁-42_{T} may be referred to as “tensile” members.

In this embodiment, the support members 42₁-42_{T} are elongated and extend from the annular beam 36 towards the hub 32 generally in the radial direction of the caster wheel 20ᵢ. In that sense, the support members 42₁-42_{T} may be referred to as “spokes” and the annular support 41 may be referred to as a “spoked” support.

More particularly, in this embodiment, each spoke 42_{T} extends from an inner peripheral surface 48 of the annular beam 36 towards the hub 32 generally in the radial direction of the caster wheel 20ᵢ and from a first lateral end 55 to a second lateral end 57 in the lateral direction of the caster wheel 20ᵢ. In this case, the spoke 42_{T} extends in the lateral direction of the caster wheel 20ᵢ for at least a majority of a width W_{T} of the tire 34, which in this case corresponds to the width W_{W} of the caster wheel 20ᵢ. For instance, in some embodiments, the spoke 42_{T} may extend in the lateral direction of the caster wheel 20ᵢ for more than half, in some cases at least 60%, in some cases at least 80%, and in some cases an entirety of the width W_{T} of the tire 34. In other embodiments, the spokes 42_{T} may be tapered in the radial direction of the caster wheel 20ᵢ such that a width of the spokes 42_{T} decreases towards the axis of rotation 35 of the caster wheel 20ᵢ. Moreover, the spoke 42_{T} has a thickness T_{S} measured between a first surface face 59 and a second surface face 61 of the spoke 42_{T} that is significantly less than a length and width of the spoke 42_{T}.

When the caster wheel 20ᵢ is in contact with the ground and bears a load (e.g., part of the weight of the ZTR mower 10), respective ones of the spokes 42₁-42_{T} that are disposed in the upper portion 29 of the spoked support 41 (i.e., above the axis of rotation 35 of the caster wheel 20ᵢ) are placed in tension while respective ones of the spokes 42₁-42_{T} that are disposed in the lower portion 27 of the spoked support 41 (i.e., adjacent the contact patch 25) are placed in compression. The spokes 42₁-42_{T} in the lower portion 27 of the spoked support 41 which are in compression bend in response to the load. Conversely, the spokes 42₁-42_{T} in the upper portion 29 of the spoked support 41 which are placed in tension support the load by tension.

The tire 34 has an inner diameter D_{TI} and an outer diameter D_{TO}, which in this case corresponds to the outer diameter D_{W} of the caster wheel 20ᵢ. A sectional height H_{T} of the tire 34 is half of a difference between the outer diameter D_{TO} and the inner diameter D_{TI} of the tire 34. The sectional height H_{T} of the tire may be significant in relation to the width W_{T} of the tire 34. In other words, an aspect ratio AR of the tire 34 corresponding to the sectional height H_{T} over the width W_{T} of the tire 34 may be relatively high. For instance, in some embodiments, the aspect ratio AR of the tire 34 may be at least 70%, in some cases at least 90%, in some cases at least 110%, and in some cases even more. Also, the inner diameter D_{TI} of the tire 34 may be significantly less than the outer diameter D_{TO} of the tire 34 as this may help for compliance of the caster wheel 20ᵢ. For example, in some embodiments, the inner diameter D_{TI} of the tire 34 may be no more than half of the outer diameter D_{TO} of the tire 34, in some cases less than half of the outer diameter D_{TO} of the tire 34, in some cases no more than 40% of the outer diameter D_{TO} of the tire 34, and in some cases even a smaller fraction of the outer diameter D_{TO} of the tire 34.

The hub 32 is disposed centrally of the tire 34 and connects the caster wheel 20ᵢ to the axle 17 that is supported by the ZTR mower 10.

In this embodiment, as further discussed below, the hub 32 is compliant such that it is resiliently deformable in response to a given load on the caster wheel 20ᵢ. That is, the hub 32 deforms from a neutral configuration to a deformed configuration in response to the given load and recovers its neutral configuration upon the given load being removed.

Notably, in this embodiment, the hub 32 is resiliently deformable in the lateral direction of the caster wheel 20ᵢ when the caster wheel 20ᵢ is loaded in the lateral direction of the caster wheel 20ᵢ. In this example, this lateral resilient deformability of the hub 32 is achieved by the hub 32 being resiliently deformable torsionally about the horizontal direction of the caster wheel 20ᵢ (i.e., resiliently deformable by torsion about an axis of torsion parallel to the horizontal direction of the caster wheel 20ᵢ) when the caster wheel 20ᵢ is loaded in the lateral direction of the caster wheel 20ᵢ.

In this embodiment, the hub 32 comprises an inner annular member 62, an outer annular member 64 radially outward of the inner annular member 62, a resiliently-deformable intermediate member 63 interconnecting the inner annular member 62 and the outer annular member 64 and a mount 66 for mounting the caster wheel 20ᵢ to the axle 17 supported by the ZTR mower 10.

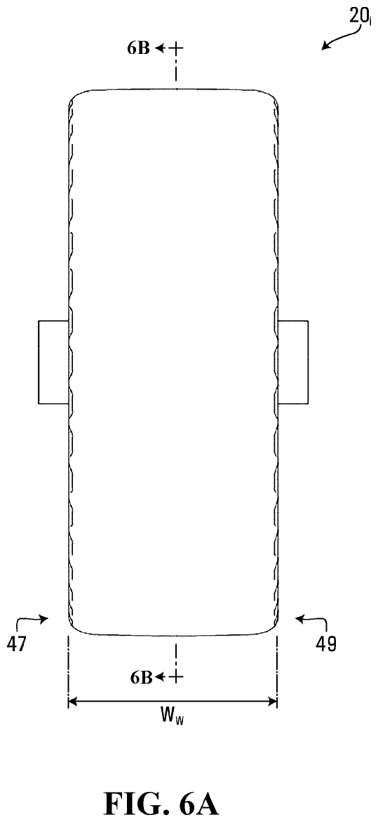

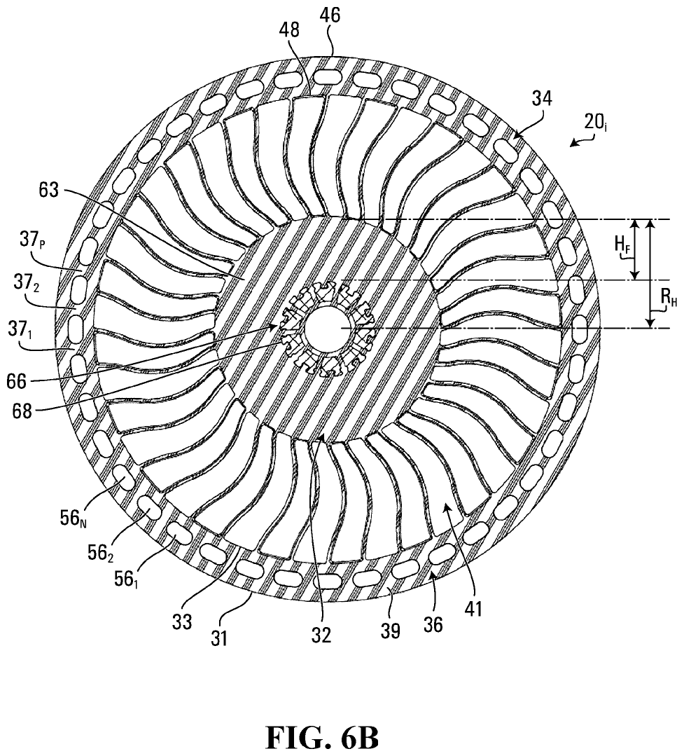

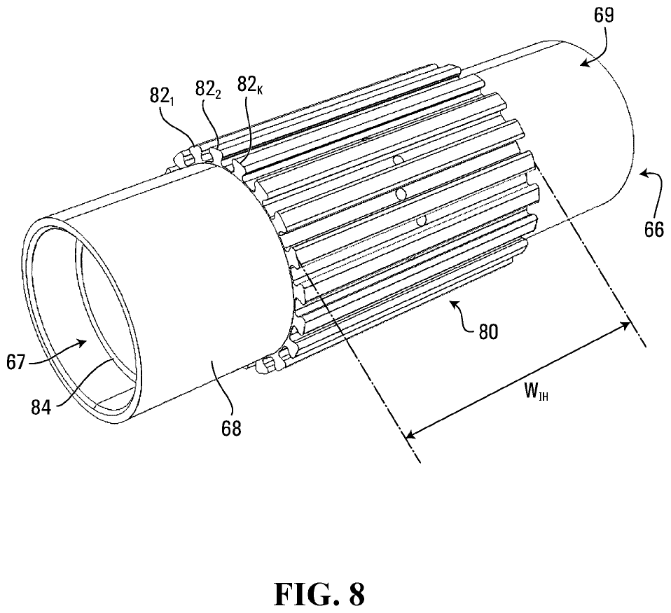

With further reference to FIG. 8, in this embodiment, the mount 66 comprises a housing 68 to house one or more bearings (not shown) which engage the axle 17 and allow the caster wheel 20ᵢ to rotate about it. The housing 68 is generally cylindrical and comprises an inner surface 67 and an outer surface 69. The mount 66 further comprises an interlocking mean 80 which generally extends around a circumference of the outer surface 69 of the housing 68. The interlocking mean 80 has a length substantially equal to a dimension W_{IH} of the inner annular member 62 of the hub 32 in the lateral direction of the caster wheel 20ᵢ. In this non-limiting embodiment, the interlocking mean 80 comprises a plurality of tapered projections 82₁-82_{K} which generally protrude away from the outer surface 69 of the housing 68. As shown in FIG. 6B, the plurality of tapered projections 82₁-82_{K} of the mount 66 may be configured to interlock with a plurality of corresponding recesses of the inner annular member 62 of the hub 32 such that a rotation of the mount 66, and therefore of the interlocking mean 80, will impart a rotational movement to the caster wheel 20ᵢ about the axle 17 via the hub 32. The plurality of tapered projections 82₁-82_{K} and the plurality of corresponding recesses may have any shape and/or any dimension in other embodiments. In yet further embodiments, the housing 68 may be chemically adhered to the inner annular member 62 of the hub 32 directly via the outer surface 69 of the housing 68. Flanges 84 may be defined circumferentially at each axial extremity of the inner surface 67 of the housing 68. The flanges 84 may be configured to receive and secure one or more bearings (not shown) which engage the axle 17 and allow the caster wheel 20i to rotate about it.

The outer annular member 64 of the hub 32 interconnects the hub 32 and the spoked support 41, namely the spokes 42_{T}.

The resiliently-deformable intermediate member 63 of the hub 32 can resiliently deform in the lateral direction of the caster wheel 20ᵢ when the caster wheel 20ᵢ is loaded in the lateral direction of the caster wheel 20ᵢ. In this embodiment, the resiliently-deformable intermediate member 63 of the hub 32 can resiliently deform torsionally about the horizontal direction of the caster wheel 20ᵢ when the caster wheel 20ᵢ is loaded in the lateral direction of the caster wheel 20ᵢ.

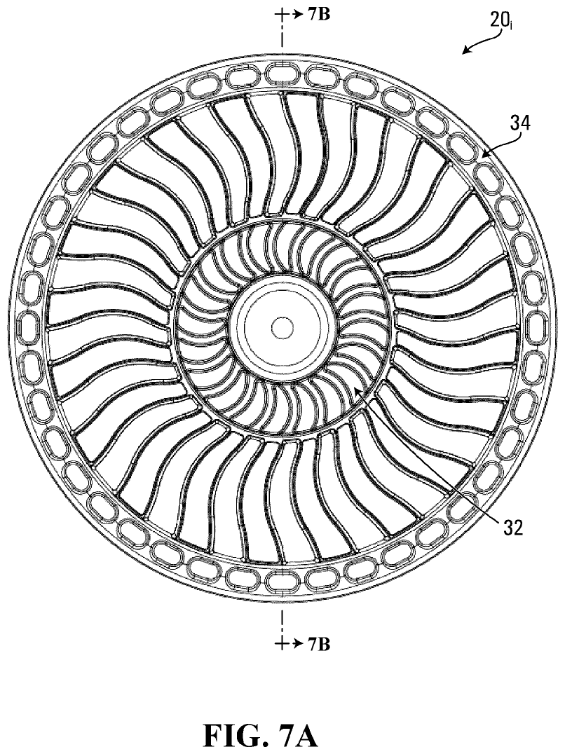

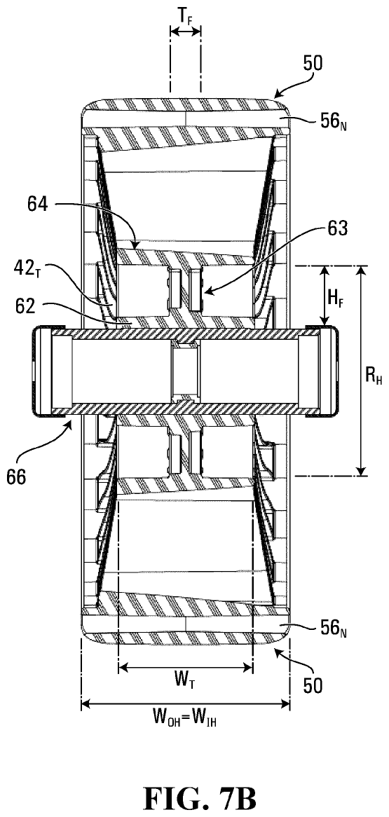

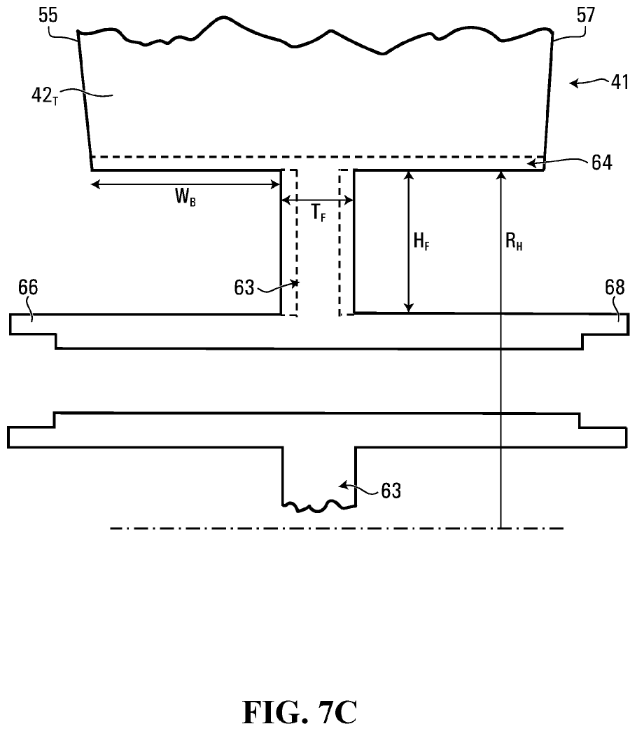

To that end, in this embodiment, the resiliently-deformable intermediate member 63 of the hub 32 is smaller in the lateral direction of the caster wheel 20ᵢ than the inner annular member 62 of the hub 32 and the outer annular member 64 of the hub 32. That is, a dimension T_{F} of the resiliently-deformable intermediate member 63 of the hub 32 in the lateral direction of the caster wheel 20ᵢ is less than the dimension W_{IH} of the inner annular member 62 of the hub 32 in the lateral direction of the caster wheel 20ᵢ and less than a dimension W_{OH} of the outer annular member 64 of the hub 32 in the lateral direction of the caster wheel 20ᵢ. The resiliently-deformable intermediate member 63 of the hub 32 thus forms a constriction of the hub 32 that facilitates resilient deformation of the hub 32 in the lateral direction of the caster wheel 20ᵢ when the caster wheel 20ᵢ is loaded in the lateral direction of the caster wheel 20ᵢ. In some embodiments, and as shown in FIG. 7B, T_{F} may vary. Specifically, the resiliently-deformable intermediate member 63 of the hub 32 may comprise a plurality of projections 65_{J} projecting in the lateral direction on each one of the lateral sides 47 and 49 of the caster wheel 20ᵢ and extending generally in the radial direction of the caster wheel 20ᵢ from the inner annular member 62 towards the outer annular member 64 of the hub 32. The plurality of projections 65_{J} defines a corresponding plurality of recesses in the resiliently-deformable intermediate member 63 such that the dimension T_{F} is smaller in the plurality of recesses than in the plurality of projection 65_{J}. In one non-limiting example, the plurality of projections 65_{J} are shaped as curved ridges. Without wishing to be bound by any theory, the curvature of the ridges may contribute to the hub 32 being resiliently deformable torsionally about the horizontal direction of the caster wheel 20ᵢ. In the case where T_{F} varies, T_{F} is taken to be the overall dimension of the resiliently-deformable intermediate member 63 of the hub 32 in the lateral direction of the caster wheel 20ᵢ.

For example, in some embodiments, a ratio of the dimension T_{F} of the resiliently-deformable intermediate member 63 of the hub 32 in the lateral direction of the caster wheel 20ᵢ over the dimension W_{IH} of the inner annular member 62 of the hub 32 in the lateral direction of the caster wheel 20ᵢ may be no more than 0.6, in some cases no more than 0.5, in some cases no more than 0.4, and in some cases no more than 0.3 or even less (e.g., 0.2 or less), and/or a ratio of the dimension T_{F} of the resiliently-deformable intermediate member 63 of the hub 32 in the lateral direction of the caster wheel 20ᵢ over the dimension W_{OH} of the outer annular member 64 of the hub 32 in the lateral direction of the caster wheel 20ᵢ may be no more than 0.6, in some cases no more than 0.5, in some cases no more than 0.4, and in some cases no more than 0.3 or even less (e.g., 0.2 or less).

Also, in this embodiment, the resiliently-deformable intermediate member 63 of the hub 32 occupies a significant part of the hub 32 in the vertical direction of the caster wheel 20ᵢ. For example, in this embodiment, a height H_{F} of the resiliently-deformable intermediate member 63 of the hub 32 may occupy a significant part of a radius R_{H} of the hub 32. For instance, in some embodiments, a ratio of the height H_{F} of the resiliently-deformable intermediate member 63 of the hub 32 over the radius R_{H} of the hub 32 may be at least 0.4, in some cases at least 0.5, in some cases at least 0.6, and in some cases at least 0.7 or even more (e.g., 0.8 or more).

In other embodiments, the resiliently-deformable intermediate member 63 of the hub 32 may further include a plurality of interconnecting parts between the inner annular member 62 and the outer annular member 64 spaced apart in the lateral direction of the caster wheel 20ᵢ.

In one non-limiting example, and for a caster wheel 20ᵢ having dimensions of 13″×6.5″, the dimension T_{F} of the resiliently-deformable intermediate member 63 of the hub 32 in the lateral direction of the caster wheel 20ᵢ may be between 10 mm and 40 mm, the height H_{F} of the resiliently-deformable intermediate member 63 of the hub 32 may be larger than 20 mm and the radius R_{H} of the hub 32 may be larger than 55 mm.

The caster wheel 20ᵢ may be made up of one or more materials. The non-pneumatic tire 34 comprises a tire material 45 that makes up at least a substantial part (i.e., a substantial part or an entirety) of the tire 34. The hub 32 comprises a hub material 72 that makes up at least a substantial part of the hub 32. In some embodiments, the tire material 45 and the hub material 72 may be different materials. In other embodiments, the tire material 45 and the hub material 72 may be a common material (i.e., the same material).

In this embodiment, the tire material 45 constitutes at least part of the annular beam 36 and at least part of the spokes 42₁-42_{T}. Also, in this embodiment, the tire material 45 constitutes at least part of the tread 50. More particularly, in this embodiment, the tire material 45 constitutes at least a majority (e.g., a majority or an entirety) of the annular beam 36, the tread 50, and the spokes 42₁-42_{T}. In this example of implementation, the tire material 45 makes up an entirety of the tire 34, including the annular beam 36, the spokes 42₁-42_{T}, and the tread 50. The tire 34 is thus monolithically made of the tire material 45. In this example, therefore, the annular beam 36 is free of (i.e., without) a substantially inextensible reinforcing layer running in the circumferential direction of the wheel 20ᵢ (e.g., a layer of metal, composite (e.g., carbon fibers, other fibers), and/or another material that is substantially inextensible running in the circumferential direction of the wheel 20ᵢ). In that sense, the annular beam 36 may be said to be “unreinforced”.

The tire material 45 is elastomeric. For example, in this embodiment, the tire material 45 is a cast elastomer or a thermoplastic elastomer such as a polyurethane (PU) elastomer. In non-limiting examples, the PU elastomer may be composed of a TDI pre-polymer, such as PET-93A or PET-95A, cured with MCDEA or MOCA, commercially available from COIM. Polyurethane formulations using ether and/or ester backbones are possible, in addition to other curatives known in the cast polyurethane industry. Other suitable resilient, elastomeric materials would include thermoplastic materials, such as HYTREL co-polymer from DuPont, Arnitel from DSM or Keyflex from LG. Materials in the 93A to 56D hardness level may be particularly useful, such as Hytrel 5526, Hytrel 4556, Arnitel EL550 or Keyflex 1055D. The tire material 45 may be any other suitable material in other embodiments.

In this embodiment, the tire material 45 may exhibit a non-linear stress vs. strain behavior. For instance, the tire material 45 may have a secant modulus that decreases with increasing strain of the tire material 45. The tire material 45 may have a high Young's modulus that is significantly greater than the secant modulus at 100% strain (a.k.a. “the 100% modulus”). Such a non-linear behavior of the tire material 45 may provide efficient load carrying during normal operation and enable impact loading and large local deflections without generating high stresses. For instance, the tire material 45 may allow the tire 34 to operate at a low strain rate (e.g., 2% to 5%) during normal operation yet simultaneously allow large strains (e.g., when the ATV 10 engages obstacles) without generating high stresses. This in turn may be helpful to minimize vehicle shock loading and enhance durability of the tire 34.

The tire 34 may comprise one or more additional materials in addition to the tire material 45 in other embodiments (e.g., different parts of the annular beam 36, different parts of the tread 50, and/or different parts of the spokes 42₁-42_{T} may be made of different materials). For example, in some embodiments, different parts of the annular beam 36, different parts of the tread 50, and/or different parts of the spokes 42₁-42_{T} may be made of different elastomers. As another example, in some embodiments, the annular beam 36 may comprise one or more substantially inextensible reinforcing layers running in the circumferential direction of the caster wheel 20ᵢ (e.g., one or more layers of metal, composite (e.g., carbon fibers, other fibers), and/or another material that is substantially inextensible running in the circumferential direction of the caster wheel 20ᵢ).

In this embodiment, the hub material 72 constitutes at least part of the inner annular member 62, the outer annular member 64, and the resiliently-deformable intermediate member 63 of the hub 32. More particularly, in this embodiment, the hub material 72 constitutes at least a majority (e.g., a majority or an entirety) of the inner annular member 62, the outer annular member 64, and the resiliently-deformable intermediate member 63 of the hub 32. In this example of implementation, the hub material 72 makes up an entirety of the outer annular member 64 and the resiliently-deformable intermediate member 63 of the hub 32.

In this example of implementation, the hub material 72 is polymeric. More particularly, the hub material 72 is a cast elastomer or a thermoplastic elastomer such as a polyurethane (PU) elastomer. In non-limiting examples, the PU elastomer may be composed of a TDI pre-polymer, such as PET-93A or PET-95A, cured with MCDEA or MOCA, commercially available from COIM. Polyurethane formulations using ether and/or ester backbones are possible, in addition to other curatives known in the cast polyurethane industry. Other suitable resilient, elastomeric materials would include thermoplastic materials, such as HYTREL co-polymer from DuPont, Arnitel from DSM or Keyflex from LG. Materials in the 93A to 60D hardness level may be particularly useful, such as Hytrel 5526, Hytrel 4556, Arnitel EL550 or Keyflex 1055D. The hub material 72 may be any other suitable material in other embodiments.

The hub 32 may comprise one or more additional materials in addition to the hub material 72 in other embodiments (e.g., different parts of the inner annular member 62 and/or the outer annular member 64 and/or the resiliently-deformable intermediate member 63 may be made of different materials and/or the mount 66 may be made of different materials). For example, in some embodiments, different parts of the inner annular member 62 and/or the outer annular member 64 and/or the resiliently-deformable intermediate member 63 may be made of different elastomers. In one non-limiting example, the resiliently-deformable intermediate member 63 may be made of a material having a Young's modulus of elasticity E_{F} between 90 MPa and 300 MPa. In another non-limiting example, the resiliently-deformable intermediate member 63 may be made of a material having a Young's modulus higher than that of the inner annular member 62 and the outer annular member 64.

A material 86 of the mount 66 may be a stiff material. Specifically, the material 86 of the mount 66 may be stiffer than the hub material 72. For instance, in some cases, the material 86 of the mount 66 may be aluminum, steel or an engineered plastic, such as Nylon, PET, PBT, and the likes. In some embodiments, the mount 66 may further comprise one or more substantially inextensible reinforcing layers running in the circumferential direction of the housing 68 of the mount 66 (e.g., one or more layers of composite (e.g., glass fibers, carbon fibers, other fibers), and/or another material that is substantially inextensible running in the circumferential direction of the housing 68). In some embodiments, a volume fraction of the one or more substantially inextensible reinforcing layers over a volume of the mount 66 is at least 10%, at least 20%, at least 30% and in some cases even more.

The caster wheel 20ᵢ may be manufactured in any suitable way. For example, in some embodiments, the tire 34 and/or the hub 32 may be manufactured via centrifugal casting, a.k.a. spin casting, which involves pouring one or more materials of the caster wheel 20ᵢ into a mold that rotates about an axis. The material(s) is(are) distributed within the mold via a centrifugal force generated by the mold's rotation. In some cases, vertical spin casting, in which the mold's axis of rotation is generally vertical, may be used. In other cases, horizontal spin casting, in which the mold's axis of rotation is generally horizontal, may be used. The caster wheel 20ᵢ may be manufactured using any other suitable manufacturing processes in other embodiments.

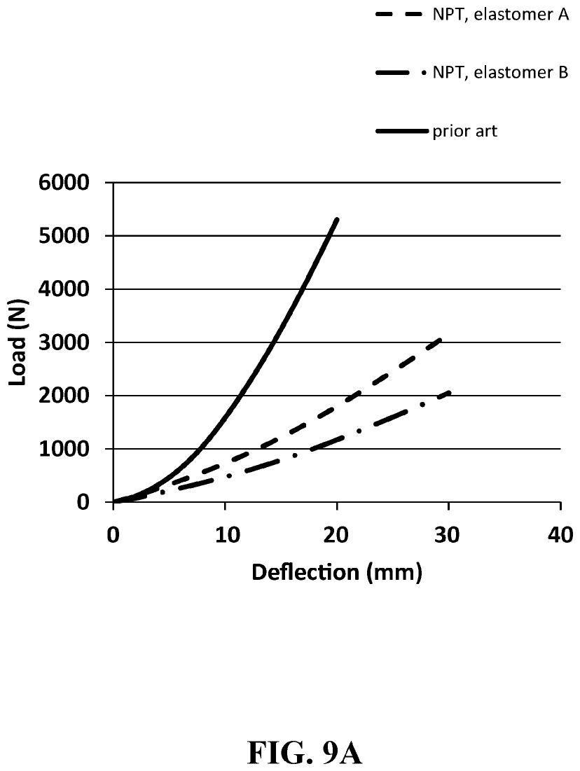

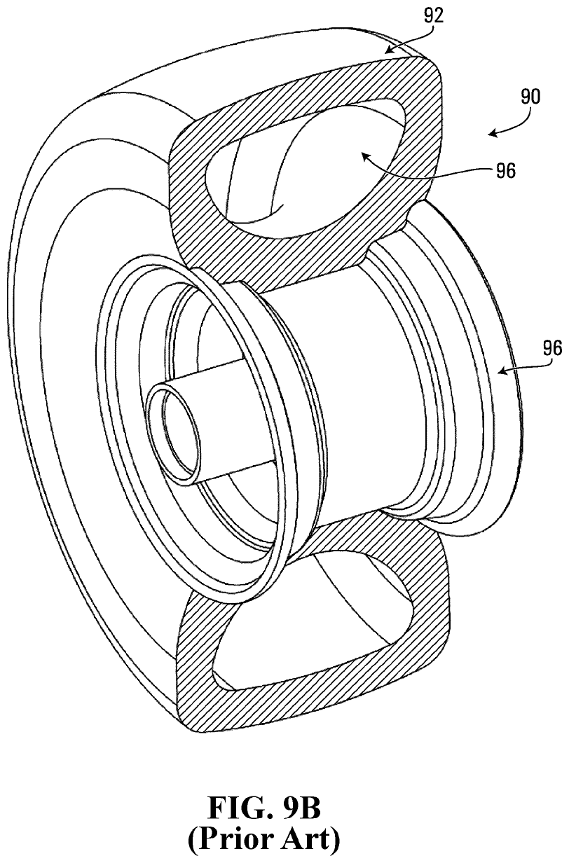

In some embodiments, a radial stiffness K_{z} of the caster wheel 20ᵢ, which is a rigidity of the caster wheel 20ᵢ in the radial direction of the caster wheel 20ᵢ (e.g., the vertical direction of the caster wheel 20ᵢ), i.e., a resistance of the caster wheel 20ᵢ to deformation in the radial direction of the caster wheel 20ᵢ when loaded in the radial direction of the wheel 20ᵢ, may be relatively low. For instance, with further reference to FIGS. 9A and 9B, the radial stiffness K_{z} of the caster wheel 20ᵢ may be lower than prior art caster wheels. FEM simulations were run for a caster wheel 20ᵢ having H_{F}=35 mm, T_{F}=18 mm and E_{F}=200 MPa (elastomer A) or E_{F}=140 MPa (elastomer B).

The prior art caster wheel 90 as shown in FIG. 9B is a semi-pneumatic caster wheel comprising a tire with an elastomeric body 92 (e.g., made of rubber), a hub 94 and a cavity 96 extending circumferentially along the elastomeric body 92. The hub 94 is metallic. A radial stiffness K_{z} of the prior art caster wheel 90 is about two times larger than the radial stiffness K_{z} of the caster wheel 20ᵢ with elastomer A and three times larger than the radial stiffness K_{z} of the caster wheel 20ᵢ with elastomer B. The prior art caster wheel 90 develops a load of 1000 N at a deflection of 7.5 mm, and has a radial stiffness K_{Z} of about 135 N/mm. Conversely, the caster wheel 20ᵢ deflects 13 mm with elastomer A or 18 mm with elastomer B at a load of 1000 N, for a radial stiffness K_{Z} of 75 N/mm and 55 N/mm, respectively.

For example, in some embodiments, the radial stiffness K_{Z} of the caster wheel 20ᵢ may be no more than 125 N/mm, in some cases no more than 100 N/mm, in some cases no more than 75 N/mm, in some cases no more than 55 N/mm and in some cases even less.

The ZTR mower 10 typically has no suspension. Additionally, the frame 12 of the ZTR mover 10 is generally very stiff in the torsional sense, such that either one of the caster wheels 20ᵢ may carry almost all the load of the ZTR mower 10 when uneven ground is traversed. For the prior art caster wheel 90, a difference in terrain height of only 7.5 mm between the left and right wheel would result in one caster wheel carrying about 200 kg, or the entire load of the ZTR mower 10. For the caster wheel 20ᵢ with elastomer B, a difference in terrain height of 7.5 mm would result in one caster wheel 20ᵢ carrying 1400 N and the other one carrying 600 N. Thus, reducing the radial stiffness K_{z} of the caster wheel 20ᵢ may help in reducing the overload on the caster wheels 20ᵢ where the frame 12 of the ZTR mover 10 is stiff in torsion. This may in turn reduce the possibility that higher ground contact pressures and forces will cause damage to the lawn.

In some embodiments, the caster wheel 20ᵢ is less laterally stiff (e.g., less torsionally stiff) to better manage lateral loading on the caster wheel 20ᵢ, such as when the ZTR mower 10 turns and/or encounters an obstacle (e.g., a stump, root, curb, etc.) at the inboard lateral side 47 or the outboard lateral side 49 of the caster wheel 20ᵢ.

More particularly, in this embodiment, the caster wheel 20ᵢ is resiliently deformable in the lateral direction of the caster wheel 20ᵢ when the caster wheel 20ᵢ is loaded in the lateral direction of the caster wheel 20ᵢ. In this example, this lateral resilient deformability of the caster wheel 20ᵢ is achieved by the caster wheel 20ᵢ being resiliently deformable torsionally about the horizontal direction of the caster wheel 20ᵢ (i.e., resiliently deformable by torsion about an axis of torsion parallel to the horizontal direction of the caster wheel 20ᵢ) when the caster wheel 20ᵢ is loaded in the lateral direction of the caster wheel 20ᵢ.

To that end, a lateral stiffness K_{y} of the caster wheel 20ᵢ may be relatively low. The lateral stiffness K_{y} of the caster wheel 20ᵢ is a rigidity of the caster wheel 20ᵢ in the widthwise (i.e., axial) direction of the caster wheel 20ᵢ, i.e., a resistance of the caster wheel 20ᵢ to deformation in the widthwise direction of the caster wheel 20ᵢ when loaded in the widthwise direction of the wheel 20ᵢ.

In this embodiment, this is achieved by a torsional stiffness Kₜₓ of the caster wheel 20ᵢ about the horizontal direction of the caster wheel 20ᵢ that is relatively low. The torsional stiffness Kₜₓ of the caster wheel 20ᵢ about the horizontal direction of the caster wheel 20ᵢ is a torsional rigidity of the caster wheel 20ᵢ about an axis of torsion parallel to the horizontal direction of the caster wheel 20ᵢ, i.e., a resistance of the caster wheel 20ᵢ to torsion about the axis of torsion when subjected to a torque about the axis of torsion resulting from loading in the lateral direction of the caster wheel 20ᵢ. The torsional stiffness Kₜₓ of the caster wheel 20ᵢ can be taken as a ratio of the torque over an angular displacement about the axis of torsion parallel to the horizontal direction of the caster wheel 20ᵢ due to that torque.

The lateral stiffness K_{y} of the caster wheel 20ᵢ may be evaluated in any suitable way in various embodiments. For example, in some cases, the lateral stiffness K_{y} of the caster wheel 20ᵢ may be gauged using a standard SAE J2718 test.

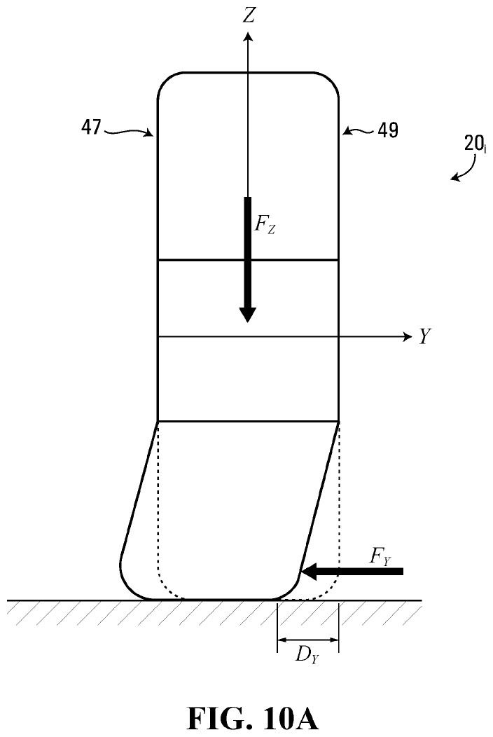

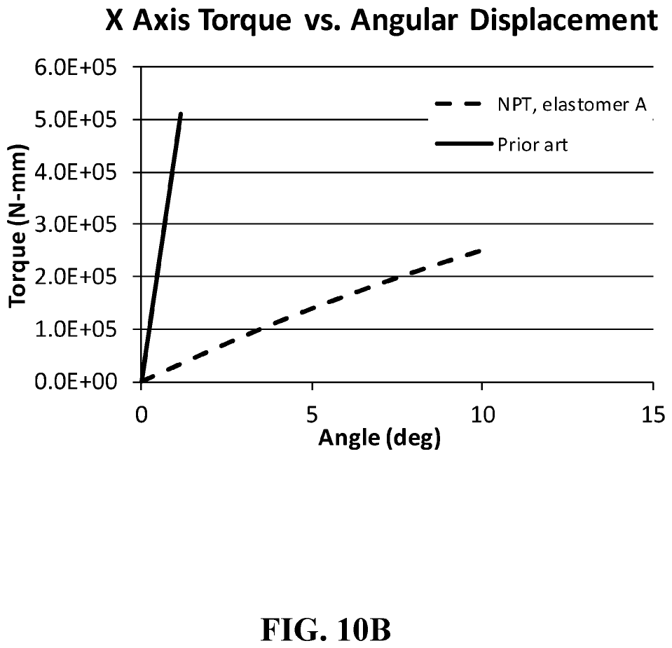

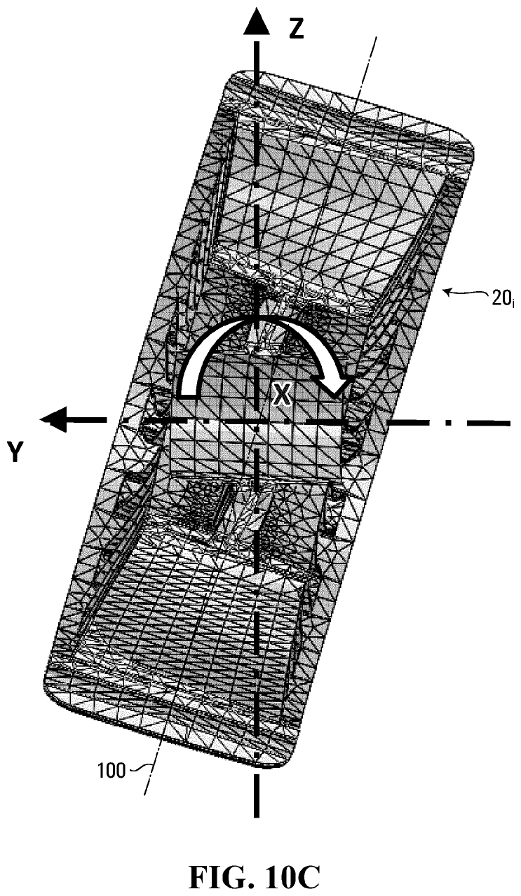

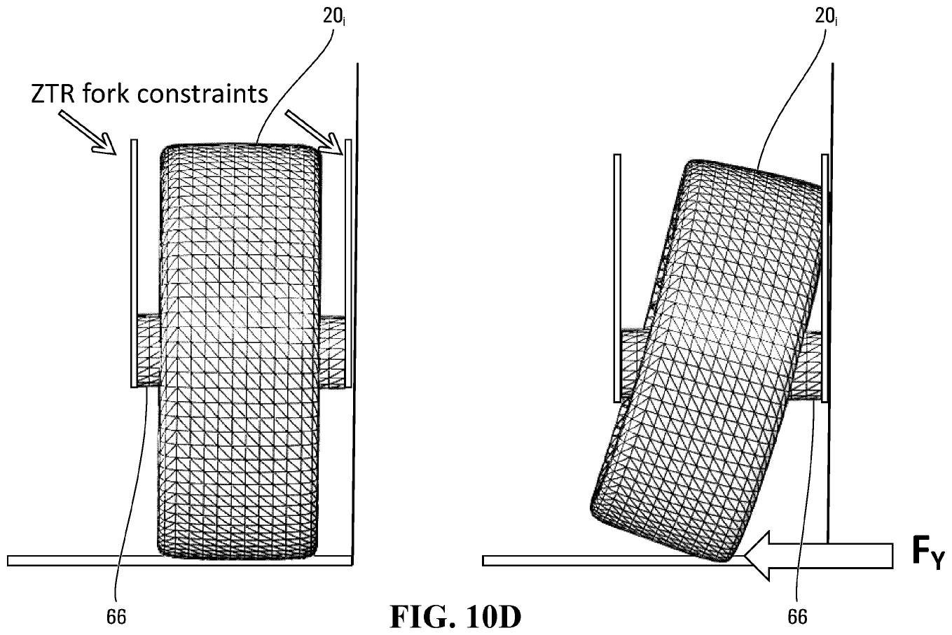

As another example, in some cases, the lateral stiffness K_{y} of the caster wheel 20ᵢ may be gauged by loading the caster wheel to load F_{z} (i.e., a vertical load), then applying a lateral load F_{y} at the contact patch, as shown in FIG. 10A. The lateral load F_{y} causes the caster wheel 20ᵢ, notably the tire 34, to elastically deform from its original configuration to a biased configuration by a deflection D_{y} in the lateral direction of the caster wheel 20ᵢ. The lateral stiffness of the caster wheel 20ᵢ is calculated as the load F_{y} over the measured lateral deflection D_{y} of the caster wheel 20ᵢ.

For instance, in some embodiments, the lateral stiffness K_{y}=F_{Y}/D_{Y} of the caster wheel 20ᵢ, when loaded to load F_{z}=1000 N, may be no more than 200 N/mm, in some cases no more than 150 N/mm, in some cases no more than 100 N/mm, in some cases no more than 80 N/mm, and in some cases even less.

The torsional stiffness Kₜₓ of the caster wheel 20ᵢ may be evaluated in any suitable way in various embodiments. For example, in some cases, and with further reference to FIGS. 10B, 10C and 10D, the torsional stiffness Kₜₓ of the caster wheel 20ᵢ may be gauged by setting the caster wheel 20ᵢ such that the caster wheel 20ᵢ is loaded to load F_{z} (i.e., a vertical load) against a flat surface and with a constraint on the mount 66 such that the mount 66 remains stationary when a lateral load F_{y} is applied. A lateral load F_{y} is then applied on the lower half of a side of the caster wheel 20ᵢ which causes the caster wheel 20ᵢ, notably the tire 34, to deform by torsion about an axis of torsion parallel to the horizontal direction of the caster wheel 20ᵢ, i.e. along or parallel to the X axis, the mount 66 being stationary. The angular displacement is equal to the angle between a radial plane 100 of the tire 34 when the tire 34 is in the original configuration and the radial plane 100 of the tire 34 when the tire 34 is in a biased configuration. The torsional stiffness Kₜₓ of the caster wheel 20ᵢ is calculated as the torque resulting from the load F_{y} over the measured angular displacement of the caster wheel 20ᵢ. The torque resulting from the load F_{y} is calculated as the product of a moment arm times the load F_{y}. The moment arm, in this case, is the distance from the flat surface to the center of rotation of the mount 66, when the caster wheel 20ᵢ is loaded to the design load.

The torsional stiffness Kₜₓ of the caster wheel 20ᵢ may be relatively low. For instance, in some embodiments, when loaded to load F_{z}=1000 N, the torsional stiffness Kₜₓ of the caster wheel 20ᵢ may be no more than 100,000 N-mm/deg, in some cases no more than 50,000 N-mm/deg, in some cases no more than 30,000 N-mm/deg, and in some cases even less. With reference to FIG. 10B, the prior art caster wheel 90 exhibits a torsional stiffness of about 430,000 N-mm/deg while the caster wheel 20ᵢ exhibits a torsional stiffness Kₜₓ of about 25,000 N-mm/deg with elastomer A. The torsional stiffness Kₜₓ of the caster wheel 20ᵢ may facilitate displacement in the Y direction when subjected to the lateral load F_{y}. This may be beneficial for the operation of the ZTR mower 10.

In some embodiments, the lateral stiffness K_{y} of the caster wheel 20ᵢ and/or the torsional stiffness Kₜₓ of the caster wheel 20ᵢ may be no more, and in some cases significantly lower, than the radial stiffness K_{z} of the caster wheel 20ᵢ, which is a rigidity of the caster wheel 20ᵢ in the vertical direction of the caster wheel 20ᵢ, i.e., a resistance of the caster wheel 20ᵢ to deformation in the vertical direction of the caster wheel 20ᵢ when loaded.

For example, in some embodiments, a ratio of the lateral stiffness K_{y} of the caster wheel 20ᵢ, when loaded to load FZ=1000 N, over the radial stiffness K_{z} of the caster wheel 20ᵢ may be no more than 0.8, in some cases no more than 0.6, and in some cases no more than 0.4 or even less, and/or a ratio of the torsional stiffness Kₜₓ of the caster wheel 20ᵢ over the radial stiffness K_{z} of the caster wheel 20ᵢ may be no more than 400 mm² / deg, in some cases no more than 300 mm²/deg, and in some cases no more than 200 mm²/deg or even less.

In this embodiment, reduced lateral stiffness characteristics of the caster wheel 20ᵢ are provided by a lateral stiffness K_{y-h} of the hub 32 that is relatively low. The lateral stiffness K_{y-h} of the hub 32 is a rigidity of the hub 32 in the widthwise (i.e., axial) direction of the caster wheel 20ᵢ, i.e., a resistance of the hub 32 to deformation in the widthwise direction of the caster wheel 20ᵢ when loaded in the widthwise direction of the wheel 20ᵢ. The reduced lateral stiffness characteristics of the caster wheel 20ᵢ may be provided in any other suitable way in other embodiments (e.g. by a lateral stiffness of the tire 34 that is relatively low, etc.).

More particularly, in this embodiment, this is achieved by a torsional stiffness Kₜₓ₋ₕ of the hub 32 of the caster wheel 20ᵢ about the horizontal direction of the caster wheel 20ᵢ that is relatively low. The torsional stiffness Kₜₓ₋ₕ of the hub 32 about the horizontal direction of the caster wheel 20ᵢ is a torsional rigidity of the hub 32 about an axis of torsion parallel to the horizontal direction of the wheel 20ᵢ i.e., a resistance of the hub 32 to torsion about the axis of torsion when subjected to a torque about the axis of torsion resulting from loading in the lateral direction of the caster wheel 20ᵢ. The torsional stiffness Kₜₓ₋ₕ of the hub 32 can be taken as a ratio of the torque over an angular displacement about the axis of torsion parallel to the horizontal direction of the wheel 20ᵢ due to that torque.

The lateral stiffness K_{y-h} of the hub 32 may be evaluated in any suitable way in various embodiments. For example, in some cases, the lateral stiffness K_{y-h} of the hub 32 may be gauged using a standard SAE J2718 test.

As another example, in some cases, the lateral stiffness K_{y-h} of the hub 32 may be gauged by separating the hub 32 from the caster wheel 20i and setting the hub 32 such that an outer radial extent of the hub 32 rests against a flat surface and applying a lateral load F_{y} on a radially central point of the hub. The load F_{y} causes the hub 32 to elastically deform from its original configuration to a biased configuration by a deflection D_{y-h}. The deflection D_{y-h} is equal to a movement of the central portion of the hub when load F_{y} is applied. The lateral stiffness of the hub 32 is calculated as the load F_{y} over the measured lateral deflection D_{y-h} of the hub 32.

For instance, in some embodiments, the lateral stiffness K_{y-h}=F_{Y}/D_{Y-h} of the hub 32 may be no more than 200 N/mm, in some cases no more than 150 N/mm, in some cases no more than 100 N/mm, and in some cases even less.

The torsional stiffness Kₜₓ₋ₕ of the hub 32 may be evaluated in any suitable way in various embodiments. For example, in some cases, the torsional stiffness Kₜₓ₋ₕ of the hub 32 may be gauged by separating the hub 32 from the caster wheel 20i and setting the hub 32 with a constraint on the mount 66 such that the mount 66 is stationary. A lateral load F_{y} is then applied on the lower half of a side of the hub 32. The load F_{y} causes the hub 32 to deform by torsion about an axis of torsion parallel to the horizontal direction of the hub 32, i.e. along or parallel to the X axis, the mount 66 being stationary. The angular displacement is equal to the angle between a radial plane of the hub 32 when the hub 32 is in the original configuration and the radial plane of the hub 32 when the hub 32 is in a biased configuration. The torsional stiffness Kₜₓ₋ₕ of the hub 32 is calculated as the torque resulting from the load F_{y} over the measured angular displacement of the hub 32.

The torsional stiffness Kₜₓ₋ₕ of the hub 32 may be relatively low. For instance, in some embodiments, the torsional stiffness Kₜₓ₋ₕ of the hub 32 may be no more than 35,000 N-mm/deg, in some cases no more than 25,000 N-mm/deg, in some cases no more than 15,000 N-mm/deg, and in some cases even less. The hub 32 has a torsional stiffness Kₜₓ₋ₕ that may facilitate displacement in the Y direction when subjected to the lateral load F_{y}. This may be beneficial for the operation of the ZTR mower 10.

In some embodiments, the pressure applied at the contact patch 25 of the caster wheel 20ᵢ onto the ground may be more uniformly or otherwise better distributed. For example, this may be useful to reduce, minimize or eliminate potential for damaging the lawn as the caster wheel 20ᵢ moves on it.

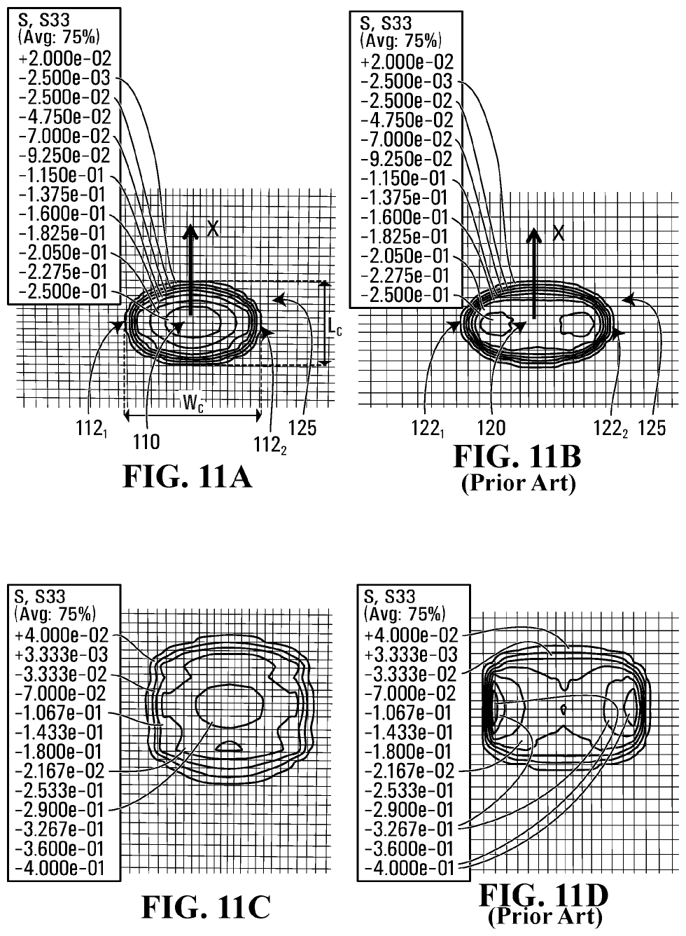

For instance, with additional reference to FIGS. 11A-11D, in some embodiments, a pressure distribution at the contact patch 25 of the caster wheel 20ᵢ on the ground may be such that the pressure is greatest centrally of the contact patch 25 of the caster wheel 20ᵢ in the widthwise direction of the caster wheel 20ᵢ. That is, the pressure is greatest in a central region 110 of the contact patch 25 of the caster wheel 20ᵢ in the widthwise direction of the caster wheel 20ᵢ. The central region 110 of the contact patch 25 of the caster wheel 20ᵢ is that region of the contact patch 25 corresponding to a central third of the contact patch 25 in the widthwise direction of the caster wheel 20ᵢ and a central third of the contact patch 25 in the horizontal direction of the caster wheel 20ᵢ. Alternatively, the central region 110 of the contact patch 25 can be defined as a region immediately surrounding a centroid of the contact patch 25 and having a same centroid as the contact patch. This region may be elliptical in form, having a major axis in the lateral direction of the caster wheel 20ᵢ corresponding to about one-third of the dimension W_{C} of the contact patch 25 in the lateral direction of the caster wheel 20ᵢ, and having a minor axis in the horizontal, or X direction, of the caster wheel 20ᵢ corresponding to about one-third of the dimension L_{c} in the horizontal direction of the caster wheel 20ᵢ. The pressure substantially decreases away from the central region 110 of the contact patch 25 of the caster wheel 20ᵢ in the lateral direction of the caster wheel 20ᵢ towards extremities 112₁, 112₂ of the contact patch 25 of the caster wheel 20ᵢ in the lateral direction of the caster wheel 20ᵢ.

FIGS. 11A and 11C show FEM predictions for pressure distribution at the contact patch 25 of the caster wheel 20ᵢ when vertically loaded at a usual operating load of 1000 N and at a load of 2000 N, respectively, on a deformable surface. At the load of 1000 N, the pressure is the highest in the central third of the contact patch 25 of the caster wheel 20ᵢ (i.e., with reference to FIG. 11A, 0.22 MPa in the central region 110 compared to 0.14 MPa average pressure at the contact patch 25). This may remain even as loading on the caster wheel 20ᵢ in the vertical direction of the caster wheel 20ᵢ increases. For example, the pressure remains the highest in the central third of the contact patch 25 and generally uniform when the load on the caster wheel 20ᵢ is doubled (i.e., with reference to FIG. 11C, 0.28 MPa in the central region 110 compared to 0.21 MPa average pressure at the contact patch 25).

The pressure distribution at the contact patch 25 of the caster wheel 20ᵢ may be significantly different and better than that of prior art caster wheels. For example, FIGS. 11B and 11D show FEM predictions for pressure distribution at a contact patch 125 of a prior art caster wheel on the ground, in which the prior art caster wheel is the prior art caster wheel 90 as shown in FIG. 9B. Pressure applied by the prior art caster wheel 90 onto the ground is greatest adjacent to extremities 122₁, 122₂ of the contact patch 125 of the prior art caster wheel 90 in a widthwise direction of the caster wheel 90, not in a central region 120 of the contact patch 125 (i.e., with reference to FIG. 11B, 0.21 MPa in extremities 122₁, 122₂ compared to 0.16 MPa average pressure at the contact patch 25). These pressure peaks adjacent to the extremities 122₁, 122₂ of the contact patch 125 of the prior art caster wheel 90 may be undesirable as they can damage the lawn. This situation may worsen when vertical loading on the prior caster wheel 90 is increased (e.g., doubled), as the pressure peaks move even more towards the extremities 122₁, 122₂ of the contact patch 125 with a spike in pressure of up to 0.5 MPa (75 psi) (i.e., with reference to FIG. 11D, 0.52 MPa in extremities 122₁, 122₂ compared to 0.31 MPa average pressure at the contact patch 25).

In other embodiments, the contact patch 25 of the caster wheel 20ᵢ may be made of a material 130 different from the tire material 45. The material 130 may be rubber, a cast elastomer like polyurethane, or a thermoplastic elastomer that can be easily adhered to the tire material 45 during an overmolding operation in injection molding. In a non-limiting example, the material 130 may be Hytrel 3076 or any material having a low shore hardness of around 75 A and a modulus of around 30 MPa.

In some embodiments, each drive wheel 21ᵢ of the ZTR mower 10 may be constructed according to principles discussed herein, including by having its tire 210 as a non-pneumatic tire similar in construction to the non-pneumatic tire 34 of the caster wheel 20ᵢ instead of a pneumatic tire. In such cases, the ZTR mower 10 may be entirely supported on the ground by non-pneumatic tires.

While in embodiments considered above the caster wheel 20ᵢ is part of the ZTR mower 10, a caster wheel constructed according to principles discussed herein may be used as part of other vehicles or other devices in other embodiments. For example, in some embodiments, a caster wheel constructed according to principles discussed herein may be part of a work implement, such as rotary cutter, sometimes referred to as a “brush” hog or “bush hog”, that is attachable to a back of a tractor or other vehicle (e.g., using a three-point hitch and powered via a power take-off) to cut or perform other work on the ground.

Also, although in embodiments considered above the wheel 20ᵢ is a caster wheel, a wheel constructed according to principles discussed herein may not be a caster wheel but rather another type of wheel in other embodiments. For example, riding lawn mowers that are not ZTR have front wheels that do not function as a caster wheel. Yet, the front tires of these mowers can also be subjected to impact loads in the lateral direction. Principles disclosed herein can also be applied to such tires. Furthermore, larger tires used for all-terrain vehicles (ATVs) can benefit from lower torsional and/or lower lateral stiffness. These tires can be much larger than the 13″×6.5″ generally considered here. ATV tires can be 25-29″ in diameter and 9″ to 12″ in width. Use of a hub that has a designed torsional compliance around the X axis may improve performance of tires for these vehicles.

As another example, in some embodiments, a wheel constructed according to principles discussed herein in respect of the wheel 20ᵢ may be used as part of an agricultural vehicle (e.g., a tractor, a harvester, etc.), a material-handling vehicle, a forestry vehicle, or a military vehicle.

As another example, in some embodiments, a wheel constructed according to principles discussed herein in respect of the wheel 20ᵢ may be used as part of a road vehicle such as an automobile or a truck or a motorcycle or any other suitable vehicle.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for the purpose of describing, but not limiting, the invention. Various modifications and enhancements will become apparent to those of ordinary skill in the art and are within the scope of the invention.

1. A wheel comprising a non-pneumatic tire, wherein: a lateral direction of the wheel is parallel to an axis of rotation of the wheel; and the wheel is resiliently deformable in the lateral direction of the wheel.

2. The wheel of claim 1, wherein: a vertical direction of the wheel is normal to the axis of rotation of the wheel; a horizontal direction of the wheel is normal to the axis of rotation of the wheel and the vertical direction of the wheel; and the wheel is resiliently deformable in the lateral direction of the wheel by being resiliently deformable torsionally about the horizontal direction of the wheel.

3. The wheel of claim 1, wherein the non-pneumatic tire comprises an annular beam configured to deflect at a contact patch of the non-pneumatic tire.

4. The wheel of claim 3, comprising an annular support disposed radially inwardly of the annular beam and resiliently deformable such that, when the non-pneumatic tire is loaded, a lower portion of the annular support below the axis of rotation of the wheel is compressed and an upper portion of the annular support above the axis of rotation of the wheel is in tension.

5. The wheel of claim 1, wherein a lateral stiffness of the wheel is lower than a radial stiffness of the wheel.

6. The wheel of claim 5, wherein a ratio of the lateral stiffness of the wheel when loaded to a vertical load of 1000 N over the radial stiffness of the wheel is no more than 0.8.

7. The wheel of claim 5, wherein a ratio of the lateral stiffness of the wheel when loaded to a vertical load of 1000 N over the radial stiffness of the wheel is no more than 0.6.

8. (canceled)

9. The wheel of claim 1, wherein a radial stiffness of the wheel is no more than 125 N/mm.

10. (canceled)

11. (canceled)

12. The wheel of claim 1, wherein a lateral stiffness of the wheel is no more than 200 N/mm when loaded to a vertical load of 1000 N.

13. The wheel of claim 1, wherein a lateral stiffness of the wheel is no more than 150 N/mm when loaded to a vertical load of 1000 N.

14. (canceled)

15. (canceled)

16. (canceled)

17. (canceled)

18. (canceled)

19. (canceled)

20. The wheel of claim 2, wherein a ratio of a torsional stiffness of the wheel when loaded to a vertical load of 1000 N over a radial stiffness of the wheel is no more than 400 mm²/deg.

21. The wheel of claim 2, wherein a ratio of a torsional stiffness of the wheel when loaded to a vertical load of 1000 N over a radial stiffness of the wheel is no more than 300 mm2/deg.

22. (canceled)

23. (canceled)

24. (canceled)

25. (canceled)

26. The wheel of claim 2, wherein a torsional stiffness of the wheel about the horizontal direction of the wheel when loaded to a vertical load of 1000 N is no more than 100,000 N-mm/deg.

27. The wheel of claim 2, wherein a torsional stiffness of the wheel about the horizontal direction of the wheel when loaded to a vertical load of 1000 N is no more than 50,000 N-mm/deg.

28. (canceled)

29. (canceled)

30. (canceled)

31. (canceled)

32. The wheel of claim 3, wherein a pressure is highest in a central portion of the contact patch of the non-pneumatic tire.

33. The wheel of claim 1, comprising a hub resiliently deformable in the lateral direction of the wheel.

34. The wheel of claim 33, wherein a lateral stiffness of the hub is no more than 200 N/mm.

35.

36. (cancelled)

37. The wheel of claim 33, wherein the hub comprises an inner annular member, an outer annular member radially outward of the inner annular member, and a resiliently-deformable intermediate member interconnecting the inner annular member and the outer annular member and resiliently deformable in the lateral direction of the wheel.

38. The wheel of claim 37, wherein the resiliently-deformable intermediate member of the hub is resiliently deformable in the lateral direction of the wheel by being resiliently deformable torsionally about the horizontal direction of the wheel.

39. The wheel of claim 38, wherein a torsional stiffness of the hub about the horizontal direction of the wheel is no more than 35,000 N-mm/deg.

40. (canceled)

41. (canceled)

42. (canceled)

43. The wheel of claim 37, wherein the resiliently-deformable intermediate member of the hub is smaller in the lateral direction of the wheel than the inner annular member of the hub and the outer annular member of the hub.

44. The wheel of claim 43, wherein a ratio of a dimension of the resiliently-deformable intermediate member of the hub in the lateral direction of the wheel over a dimension of the inner annular member of the hub in the lateral direction of the wheel is no more than 0.6.

45. (canceled)

46. (canceled)

47. The wheel of claim 37, wherein the inner annular member of the hub comprises a mount for mounting the wheel to the axle.

48. The wheel of claim 47, wherein the mount comprises a housing to house a bearing engaging the axle.

49. The wheel of claim 3, wherein the annular beam is free of a substantially inextensible reinforcing layer running in a circumferential direction of the non-pneumatic tire.

50. The wheel of claim 3, wherein the annular beam is configured to deflect more by shearing than by bending at the contact patch of the non-pneumatic tire.

51. (canceled)

52. (canceled)

53. (canceled)

54. (canceled)

55. (canceled)

56. (canceled)

57. The wheel of claim 3, wherein the annular beam comprises a plurality of openings distributed in the circumferential direction of the non-pneumatic tire.

58. (canceled)

59. (canceled)

60. (canceled)

61. The wheel of claim 1, wherein the wheel is a caster wheel for a vehicle.

62. The caster wheel of claim 61, wherein the vehicle is a zero-turning-radius mower.

63. (canceled)

64. (canceled)

65. (canceled)

66. A wheel comprising a non-pneumatic tire, wherein: a lateral direction of the wheel is parallel to an axis of rotation of the wheel; a radial direction of the wheel is normal to the lateral direction of the wheel; the wheel is resiliently deformable in the lateral direction of the wheel; and a lateral stiffness of the wheel is no more than a radial stiffness of the wheel.

67. (canceled)

68. A wheel comprising:
a non-pneumatic tire comprising an annular beam configured to deflect at a contact patch of the non-pneumatic tire; and
an annular support disposed radially inwardly of the annular beam and resiliently deformable such that, when the non-pneumatic tire is loaded, a lower portion of the annular support below an axis of rotation of the wheel is compressed and an upper portion of the annular support above the axis of rotation of the wheel is in tension;
wherein a pressure is highest in a central portion of the contact patch of the non-pneumatic tire.

69-135. (canceled)
